(19) United States
(12) Patent Application Publication
(10) Pub. No.: US 2005/0086161 A1
(43) Pub. Date: Apr. 21, 2005

(54) Deterrence of phishing and other identity theft frauds

(76) Inventor: Stephen I. Gallant, Cambridge, MA (US)

Correspondence Address: Jay Sandvos;Bromberg & Sunstein LLP, 125 Summer Street, Boston, MA, 02110-1618, US

(21) Appl. No.: 11/030,274

(22) Filed: Jan. 6, 2005

(51) Int. Cl. G06F 17/60

(52) U.S. Cl. 705/39

(57) ABSTRACT

Techniques are introduced for reducing internet phishing and identity theft and for helping to capture criminals who perpetrate such frauds. Invalid financial data for use in deterring fraud is generated and stored in an electronic database. The invalid financial data is made publicly accessible for use by individuals when approached with a suspicious attempt to obtain financial data. Financial transactions are monitored to detect any attempted use of the invalid financial data stored in the electronic database.

### FIELD OF THE INVENTION

This invention generally relates to the fields of computers, communication, business and law enforcement, and more specifically to deterring and punishing crime related to credit cards, the internet, and telephones.

### BACKGROUND ART

A major type of internet fraud is “phishing,” which consists of tricking an unwary email or internet user into revealing credit card, bank account number, or other personal information, often through email and web sites that pretend to be legitimate businesses such as banks. Losses due to phishing were estimated at $137M globally in 2004 according to a study from research and consulting firm TowerGroup. A September 2004 survey commissioned by TRUSTean, an online privacy non-profit organization, and NACHA, an electronic payments association, put US phishing losses to date at $500M. Phishing is a major contributor to identity theft wherein thieves are able to assume the financial identity of a victim and exploit credit cards, bank accounts, and other sources of funds. The FBI has recognized identity theft as the fastest-growing crime in the United States (online Wall Street Journal, Dec. 16, 2004). Business Week Online (Dec. 20, 2004) reports estimates that as many as 0.5% of all emails are phishing scams.

Current approaches to preventing phishing may be technically involved, expensive to implement, or offer only partial protection for naïve internet users. These proposals include authentication approaches (e.g., U.S. patent application Ser. Nos. 20040254890 and 20040236838), cryptographic approaches (e.g., U.S. patent application Ser. Nos. 20040252841 and 20040252842), approaches involving hardware (e.g., U.S. patent application Ser. No. 20040233040), special identification PINs (e.g., U.S. patent application Ser. Nos. 20040230538 and 20040187013), and account monitoring systems (e.g., U.S. patent application Ser. Nos. 20040177046 and 20020087460).

Another approach is through general anti-spam filtering of email messages (e.g., U.S. Pat. No. 6,732,157). This approach can be useful, although no anti-spam system is perfect and thieves continually adopt approaches to get more of their messages past anti-spam software. Another problem is that anti-spam software will sometimes filter out legitimate messages from financial institutions, resulting in missed messages or in the user partially or entirely disabling such software. Along this line, PayPal offers special software, a “safety bar” for Microsoft,Outlook e-mail accounts, that requires the user to download and install such software. It is claimed to be effective, but not 100% effective.

Still another approach to stopping phishing is to encourage prompt reporting of fraud attempts to a central location, followed by police/legal action to close down the web site involved in collecting user information. This approach can be effective, but involves a delay during which criminals are collecting information from unsuspecting victims.

Another type of fraud is where a criminal makes a phone call to an unsuspecting victim and pretends to be that person's bank or credit card company in order to convince that person to divulge sensitive personal financial information over the phone.

### SUMMARY OF THE INVENTION

Embodiments of the present invention are for reducing internet phishing and identity theft, and for helping to capture criminals who perpetrate such frauds. Invalid financial data for use in deterring fraud is generated and stored in an electronic database. The invalid financial data is made publicly accessible for use by individuals when approached with a suspicious attempt to obtain financial data. Financial transactions are monitored to detect any attempted use of the invalid financial data stored in the electronic database.

In another embodiment, invalid financial data is generated for use in deterring fraud. The invalid financial data is provided on a publicly accessible internet site for use by individuals when approached with a suspicious attempt to obtain financial data. Financial transactions are monitored to detect any attempted use of the invalid financial data.

In another specific embodiment, financial institutions generate invalid financial data for use in deterring fraud. The financial institutions further encourage recipients of email attempts at fraud to forward such email to a central location such as the financial institution itself. The financial institution then responds to such forwarded email fraud attempts pretending to be the intended victim, but using the invalid financial data. The financial institution then monitors financial transactions to detect attempted use of the invalid financial data. For example, the responding may include providing multiple responses using different sets of financial data.

The invalid financial data may include invalid credit card data. Embodiments may further include taking law enforcement action when an attempted use of the invalid financial data is detected. Embodiments may also include offering a reward to induce individuals to provide such invalid financial data when approached with a suspicious attempt to obtain financial data.

The suspicious attempt to obtain financial data may be based on an email message, telephone call, or personal approach from a person seeking to induce the recipient to divulge personal financial information. In some cases, one or more financial transactions may be permitted with the invalid financial data to improve chances of apprehending and prosecuting the person attempting the transaction.

### BRIEF DESCRIPTION OF THE DRAWINGS

FIG. 1 is a functional block diagram of actions taken by a bank, credit card company, or other business or organization according to one embodiment of the present invention.

FIG. 2 is a functional block diagram of actions taken by a user according to one embodiment of the present invention.

### DETAILED DESCRIPTION OF SPECIFIC EMBODIMENTS

Embodiments of the present invention are directed at attacking computer-based financial fraud such as phishing by enlisting public-spirited and knowledgeable users to provide criminals with “poisoned” financial data such as credit card numbers, bank account numbers, and other sensitive financial information. Such poisoned financial data is known to the supplying financial organization as data that can only be used in an attempted fraudulent transaction similar to the use of a stolen credit card number after a theft is discovered. The involved commercial entities such as credit card companies and merchants can then apply law enforcement measures in reaction to any attempted use of the poisoned data, for example, at the first attempted use of a poisoned credit card number, poisoned bank account number, or other sensitive financial information.

A criminal normally assumes that a stolen credit card number will be accepted for at least several charges. By significantly raising the probability that a criminal will be caught on the very first use of a stolen credit card number, such frauds are deterred. Moreover, the opportunities for identifying, capturing, and prosecuting such criminals are increased. Making phishing and other frauds less attractive to criminals will also reduce the incidence of such fraud and thereby offer increased protection to all email users. And reducing the attractiveness of phishing frauds will lead to the reduction of phishing emails which are annoying to a great many email users. Additionally, a reduction of phishing and identity fraud will result in significant savings, particularly to banks and credit card companies.

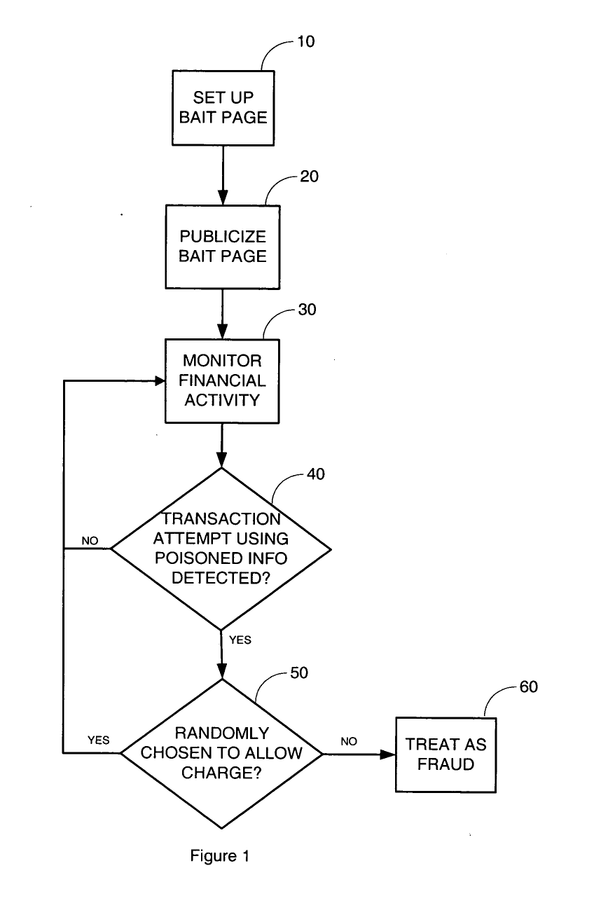

FIG. 1 is a functional block diagram according to one embodiment of the present invention showing actions taken by a financial organization. The bank or other financial organization initially generates invalid financial data for use in deterring fraud. Examples of such invalid financial data include without limitation credit card numbers, expiration dates, validation codes, bank account numbers, secret passwords, mother's maiden names, social security numbers, and other sensitive financial information. The invalid financial data is then stored in an electronic database. None of the poison financial data will be valid for use in any business transaction, and, moreover, the poison information will be known to financial institutions as invalid information for the purpose of catching criminals. Criminals will not know whether information they fraudulently extract is poison or not.

For example, one embodiment establishes a web page (or telephone service) referred to as a BAIT (“Battle Against Identity Theft”) web page, 10 in FIG. 1. The BAIT web page makes the poisoned personal financial data such as poison credit card numbers publicly available for use by individuals when approached with a suspicious attempt to obtain financial data. The BAIT web page keeps track of the poisoned information given out, and also identifies each user sufficiently to provide any award the bank may offer for successful criminal prosecution arising from that user's cooperation. For example, a database may be maintained for poison personal financial data and user contact information, which can be used to contact reward winners. Other techniques that are well known to skilled practitioners of computer science, database programming, and web design may also be useful along these lines.

Along with establishing the BAIT web page 10 and supporting computer programming, the bank or other financial institution should also predetermine what action to take when a criminal attempts to use a poison credit card number or other poison financial information. In the specific case of credit card numbers, one possible action is to treat poison credit card numbers as stolen, and to employ the same responses as are already in place for dealing with attempts to make charges on a card that a bank knows to be stolen or suspects may have been stolen. In addition or alternatively, other response tactics may also be instituted, including summoning the police when a criminal tries to get credit card authorization in order to capture and prosecute the criminal. Similar actions are available for other types of attempted fraud. These various options are well known to those in the fields of credit card and other financial fraud and law enforcement.

Once the BAIT web page and procedures are established 10, the BAIT web page is publicized 20 by the supporting financial organization. This publicity may also include announcing appropriate rewards for successful capture and prosecution of those attempting to improperly use personal financial information. Such publicity is useful to alert potential users of the existence of the BAIT page so that they can deliver poison information to those committing fraud. A collateral advantage to such publicity is that the publicity will deter criminals and thereby reduce the number of attempts at phishing and identity theft. Another advantage to the publicity is that it may attract additional media attention to this novel approach for deterring fraud and to the presence of a reward, thereby further helping the business of the bank or other financial institution. When a phishing web site (or telephone con artist) attempts to improperly extract personal financial data, the knowledgeable user will supply poisoned financial data from the BAIT web page to the criminals. This will result in some important fraction of the information that criminals collect being nothing more than traps that may lead to their arrest and prosecution.

After the BAIT web page has been created and publicized, the owning financial organization then monitors customer financial activity 30 such as credit card charges or other transactions to detect attempts to use poisoned information. Each transaction is checked to see if it involves poison data 40.

If in block 40 a given transaction does not involve poison data, monitoring continues as before in block 30. However, if an attempt to use poison financial data such as a poisoned credit card number is detected in block 40, then the BAIT page owner takes responsive action. The transaction authorization process will immediately identify any attempted transaction with poisoned financial data as attempted fraud, and trigger appropriate action on the part of the merchant. For example, the merchant may be instructed to treat such a poisoned card number exactly the same as a stolen credit card, possibly including summoning the police. It is also possible to automatically summon the police as part of the charge approval process, without any action needed on the part of the merchant.

In the embodiment shown in FIG. 1, the bank may randomly allow some small number of initial charges with poisoned credit cards, block 50. This response is to thwart criminals who devise a way to make an initial untraceable test charge or two with a stolen credit card number to verify that it will work before attempting to use it for a real fraudulent purchase. By randomly permitting 1 to 5 or even more charges before attempting to apprehend the person making the charges, the credit card company will defeat a criminal strategy of making test charges to verify the “safety” of using a stolen card.

One specific embodiment permits a random 5% of detected poison data transactions to go forward even though they are recognized as poison. Thus 5% of initial charges would be permitted, and for the 5% of charges, a second charge would be permitted for 5% of these (affecting 0.05*0.05=0.0025 of poison cards used in charges), and so on to allow some few third or greater number of charges. Once a charge is not allowed on a poison card, no further charges are allowed. Thus 95% of poison card uses would always be treated as fraud attempts on their first attempted credit card charge. In the great majority of cases where the bank decides to act in response to an attempted transaction with poison data, the predetermined fraud response procedures are followed 60.

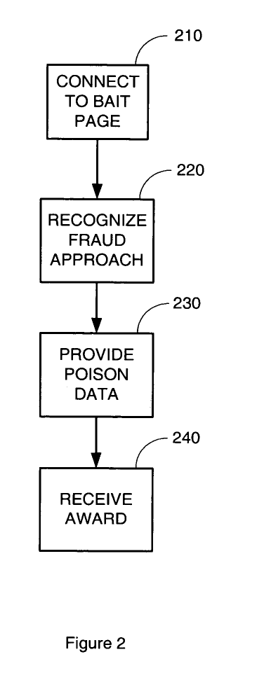

FIG. 2 further illustrates the activity of a knowledgeable user who wishes to help deter attempted fraud such as phishing and identity theft (or wishes to have a chance at a reward offered by the bank or financial institution). In the embodiment shown in FIG. 2, the user becomes aware of the bank's BAIT web page and strategy and goes to that web page to collect one or more poison credit card numbers and other personal financial information that these criminals may seek, block 210. At some time either before or after collecting the poison data, the user also recognizes a suspicious attempt to improperly obtain sensitive personal financial information, block 220. This may take the form of phishing email, phone calls purporting to be from the bank or other institution, US mail purporting to verify personal information, or other means of communication. In response, the user plays along, but divulges poisoned information from the BAIT web page rather than any actual information, block 230. This has the effect of harming the criminal's list of financial data (e.g., credit card numbers) and increases the risk to the criminal that he will be arrested in response to making an illegal charge or other financial transaction. In some embodiments, the user may also occasionally return to the BAIT page to obtain a fresh supply of poison data to help ensure their effectiveness.

In another embodiment, the user simply forwards a phishing or other fraudulent email to a financial institution. The institution then pretends to be the intended victim and directly responds to the phishing email with poisoned financial information. Responses can be repeated with different poisoned information in an attempt to further pollute the criminals' lists of financial information.

Note as explained above, that if the user has not yet obtained poisoned numbers in block 210, and the fraud attempt is not time sensitive (as often is the case with phishing email), then the user may obtain poison data in block 210 after receiving the fraud attempt in block 220. However, in other cases such as for a telephone-based fraud approach, this would be difficult because the transaction would be delayed while the user obtains poison data to give to the telephoning criminal. For such cases, it is preferable for the user to already have poison data readily available.

In block 240, after delivering one or more sets of poisoned information to those attempting to improperly obtain such information, and if other reward criteria set by the bank or financial institution have been satisfied (for example, successful prosecution for an attempted credit card charge), the user may receive a reward for his or her participation. This may involve the bank notifying the user by email or regular mail, or the user noting that one or more numbers in lists of posted award numbers match his award number, or other contact means well known to those skilled in the art of keeping contact with individuals while shielding their identity from the general public.

Embodiments of the invention may be implemented in any conventional computer and web programming language. For example, preferred embodiments may be implemented in a procedural programming language (e.g., “C”) or an object oriented programming language (e.g., “C++”) and web programming languages (e.g., “HTML” or extensions). Alternative embodiments of the invention may be implemented as pre-programmed hardware elements, other related components, or as a combination of hardware and software components.

Embodiments can be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

Although various exemplary embodiments of the invention have been disclosed, it should be apparent to those skilled in the art that various changes and modifications can be made which will achieve some of the advantages of the invention without departing from the true scope of the invention.

1. A method for reducing fraud comprising:
generating and storing in an electronic database invalid financial data for use in deterring fraud;
making the invalid financial data publicly accessible for use by individuals when approached with a suspicious attempt to obtain financial data; and
monitoring financial transactions to detect attempted use of the invalid financial data stored in the electronic database.

2. A method according to claim 1, wherein the invalid financial data includes invalid credit card data.

3. A method according to claim 1, further comprising:
when an attempted use of the invalid financial data is detected, taking law enforcement action.

4. A method according to claim 1, further comprising:
offering a reward to induce individuals to provide such invalid financial data when approached with a suspicious attempt to obtain financial data.

5. A method according to claim 1, wherein the suspicious attempt to obtain financial data is based on an email message seeking to induce the recipient to divulge personal financial information.

6. A method according to claim 1, wherein the suspicious attempt to obtain financial data is based on a telephone call seeking to induce the recipient to divulge personal financial information.

7. A method according to claim 1, wherein the suspicious attempt to obtain financial data is based on an approach from an individual seeking to induce the recipient to divulge personal financial information.

8. A method according to claim 1, further comprising:
permitting one or more financial transactions with the invalid financial data to incriminate the person making the one or more transactions.

9. A method for reducing fraud comprising:
generating invalid financial data for use in deterring fraud;
providing the invalid financial data on a publicly accessible internet site for use by individuals when approached with a suspicious attempt to obtain financial data; and
monitoring financial transactions to detect attempted use of the invalid financial data.

10. A method according to claim 9, wherein the invalid financial data includes invalid credit card data.

11. A method according to claim 9, further comprising:
when an attempted use of the invalid financial data is detected, taking law enforcement action.

12. A method according to claim 9, further comprising:
offering a reward to induce individuals to provide such invalid financial data when approached with a suspicious attempt to obtain financial data.

13. A method according to claim 9, wherein the suspicious attempt to obtain financial data is based on an email message seeking to induce the recipient to divulge personal financial information.

14. A method according to claim 9, wherein the suspicious attempt to obtain financial data is based on a telephone call seeking to induce the recipient to divulge personal financial information.

15. A method according to claim 9, wherein the suspicious attempt to obtain financial data is based on an approach from an individual seeking to induce the recipient to divulge personal financial information.

16. A method according to claim 9, further comprising:
permitting one or more financial transactions with the invalid financial data to incriminate the person making the one or more transactions.

17. A method for reducing fraud comprising:
generating invalid financial data for use in deterring fraud;
encouraging recipients of email attempts at fraud to forward such email to a central location;
responding to such forwarded email fraud attempts using the invalid financial data; and
monitoring financial transactions to detect attempted use of the invalid financial data.

18. A method according to claim 17, wherein the responding includes providing a plurality of responses using different sets of financial data.

19. A method according to claim 17, wherein the invalid financial data includes invalid credit card data.

20. A method according to claim 17, further comprising:
when an attempted use of the invalid financial data is detected, taking law enforcement action.

21. A method according to claim 17, wherein the encouraging recipients includes offering a reward to induce individuals to provide such emails when approached with a suspicious attempt to obtain financial data.

22. A method according to claim 17, further comprising:
permitting one or more financial transactions with the invalid financial data to incriminate the person making the one or more transactions.
